(19) United States
(12) Patent Application Publication
(10) Pub. No.: US 2004/0091225 A1
(43) Pub. Date: May 13, 2004

(54) Optically active waveguide device comprising a channel on an optical substrate

(76) Inventors: Stephane Serand, Marseille (FR); Laurent Roux, Marseille (FR)

Correspondence Address: Horst M Kasper, 13 Forest Drive, Warren, NJ, 07059, US

(21) Appl. No.: 10/465,973

(22) PCT Filed: Dec. 21, 2001
(86) PCT No.: PCT/FR01/04204

(30) Foreign Application Priority Data
Dec. 26, 2000 (FR) 00/17003

(51) Int. Cl. G02B 6/10

(52) U.S. Cl. 385/129; 385/132

(57) ABSTRACT

The invention concerns an optically active device comprising an optical waveguide core on an optical substrate (11, 15, 20) and a control element (32-33, 37, 40). The core comprises a channel (12, 17, 25, 35-36, 38-39) and at least an active layer (13, 18, 22) arranged on said channel, the refractive index of the channel and that of the active layer being higher than that of the substrate. The optical substrate (11, 15, 20) has a mobile ion concentration less than 0.01%. Advantageously, the device further comprises a covering layer (14, 19, 23) arranged on the active layer (13, 18, 22), the index of said covering layer being less than that of the active layer and of the channel. The invention also concerns a method for making said device.

The present invention relates to an optically-active device comprising a channel on an optical substrate.

The field of the invention is that optics integrated on a substrate, which field includes in particular active devices that serve essentially to perform functions of amplification, modulation, or switching of light signals. Such devices comprise an active waveguide and a control element which modulates one of the characteristics of the signal conveyed by the waveguide, said characteristics generally being either amplitude or phase. Such a waveguide comprises a core made on the substrate, the core having a refractive index which is higher than that of the surrounding medium.

Several methods have been proposed for making the core of an active waveguide.

A first method uses thin layer technology. In general, the substrate is made either of silica or of silicon on which a thermal oxide has been grown, such that the top face of the optical substrate is constituted by silicon dioxide. A layer of refractive index higher than that of silicon dioxide is deposited on the optical substrate by means of any conventional technique such as flame hydrolysis deposition, high or low pressure chemical vapor deposition, optionally plasma-assisted, vacuum evaporation, cathode sputtering, or deposition by centrifuging.

When making an amplifier, this layer is often made of silicon dioxide doped with a rare earth such as erbium (signal wavelength 1.55 microns (μm)) or neodymium (signal wavelength 1.3 μm). However, if a modulator or a switch is to be produced, then the layer is often constituted by a material presenting electro-optical properties, as applies to particular to certain polymers. The layer may also present thermo-optical properties, as applies for example to silicon dioxide.

A mask defining the core is then applied to the deposited layer by means of a photolithographic technique. Thereafter, the core is made by a chemical etching method or a dry etching method such as plasma etching, reactive ion etching, or ion beam etching. The mask is removed after etching and a covering layer is commonly deposited on the substrate in order to bury the core. The covering layer has a refractive index that is lower than that of the core and serves to limit the disturbances that are exerted by the surrounding medium, in particular those due to moisture.

Document GB 2 346 706 teaches a core made by means of two layers which are etched successively using a single mask. The core is thus in the form of two superposed strips presenting the same dimensions in the plane of the substrate.

That method requires an etching operation which is difficult to control both in terms of spatial resolution and in terms of the surface state of the flanks of the core. Thus, etching erbium-doped silica dioxide by means of a fluorine-containing reactive gas such as CHF₃ produces erbium fluoride, which compound significantly increases the roughness of the etched surface. Unfortunately, the surface state and the shape of the core directly determine the propagation losses of the active waveguide.

A second method described in document U.S. Pat. No. 4,834,480 implements ion exchange technology. The substrate is then a glass presenting a high concentration of ions (e.g. Na ions) that are mobile at relatively low temperature. The substrate is likewise provided with a mask and is then immersed in a bath containing active ions (e.g. K ions). The core is thus made by increasing the refractive index by exchanging active ions of the bath with the mobile ions of the substrate. More generally, the core is buried by applying an electric field perpendicularly to the face of the substrate.

That method is very simple. However, it requires a special substrate to be used and such a substrate does not necessarily have all of the desired characteristics. For example, it is not possible to exchange ions starting from silicon even though that material offers numerous advantages not only in terms of cost, of treatment methods which are the same as those used in micro-electronics, and thermal properties, but also in terms of designation. In addition, ion exchange leads to considerable lateral diffusion of the active ions, which means that spatial resolution is seriously limited in this case also.

A third method employed for making passive components implements ion implantation technology. The document “Channel waveguides formed in fused silica and silica on silicon, by Si, P and Ge ion implantation”, by P. W. Leech et al., in IEEE Proceedings: Optoelectronics Institution of Electrical Engineers, Stevenage G B, Vol. 143, No. 5, pp. 281-286, teaches a device deposited on an optical substrate of silicon dioxide. A germanium-doped layer is deposited on the substrate, and then a mask is applied and the channel is made by implanting ions in the deposited layer. This layer produces mechanical stresses which cause the substrate to be deformed. Such deformation which increases with increasing layer thickness is harmful to the optical specifications of the waveguide and leads to difficulties during the photolithographic step.

An object of the present invention is thus to provide an optically-active device that presents acceptable spatial resolution and a good surface state.

According to the invention, the device comprises a control element and a core on an optical substrate, said core having a channel and at least one active layer arranged on said channel, the refractive index of the channel and that of the active layer being higher than that of the substrate; the optical substrate is practically free from mobile ions.

On a suitable substrate, the geometrical definition of the core depends only on that of the channel since the active layer is not etched.

The device preferably includes at least one covering layer deposited on the active layer, the refractive index of said covering layer being lower than that of the active layer and than that of the channel.

In a first embodiment, the channel is integrated in the substrate.

In a second embodiment, the channel projects from the substrate.

Advantageously, the refractive index of the active layer is equal to that of the substrate multiplied by a factor greater than 1.001.

By way of example, the thickness of the set of active layers lies in the range 1 μm to 20 μm.

According to a preferred characteristic, the channel results from implanting ions into the substrate.

Furthermore, it is recommended that the face of the substrate into which ion implantation takes place is made of silicon dioxide.

By way of example, the active layer is silicon dioxide doped with a rare earth, or else a material which presents properties that are electro-optical, or thermo-optical, depending on the function of the device.

The invention also provides a method of manufacturing an active device on an optical substrate.

In a first variant, the method comprises the following steps:

making a mask on said substrate to define the pattern of a channel;

implanting ions into the masked substrate;

removing said mask; and

depositing at least one active layer on the substrate, the refractive index of said active layer being higher than that of the substrate.

In a second variant, the method comprises the following steps:

implanting ions into the substrate;

making a mask on said substrate to define the pattern of a channel;

etching the substrate to a depth that is not less than the implantation step;

removing said mask; and

depositing at least one active layer on the substrate, the refractive index of said active layer being greater than that of the substrate.

Advantageously, the method includes a step of annealing the substrate following the step of implanting ions.

The method is also adapted to achieving the various characteristics of the device mentioned above.

The present invention appears in greater detail below in the following description of embodiments given by way of illustration and with reference to the accompanying figures, in which:

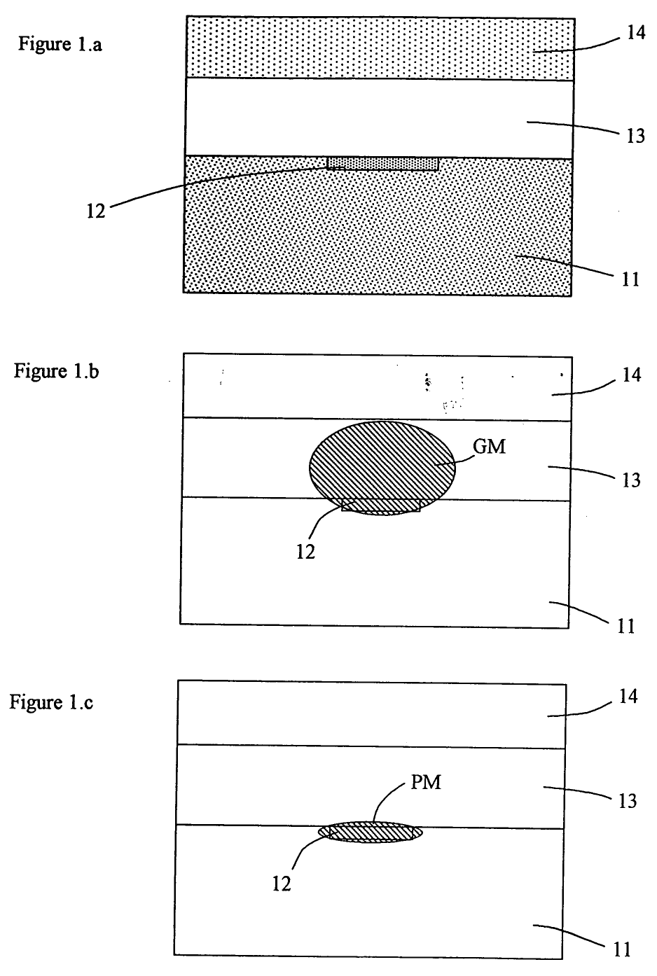

FIG. 1 is a diagrammatic section of a core of an active waveguide;

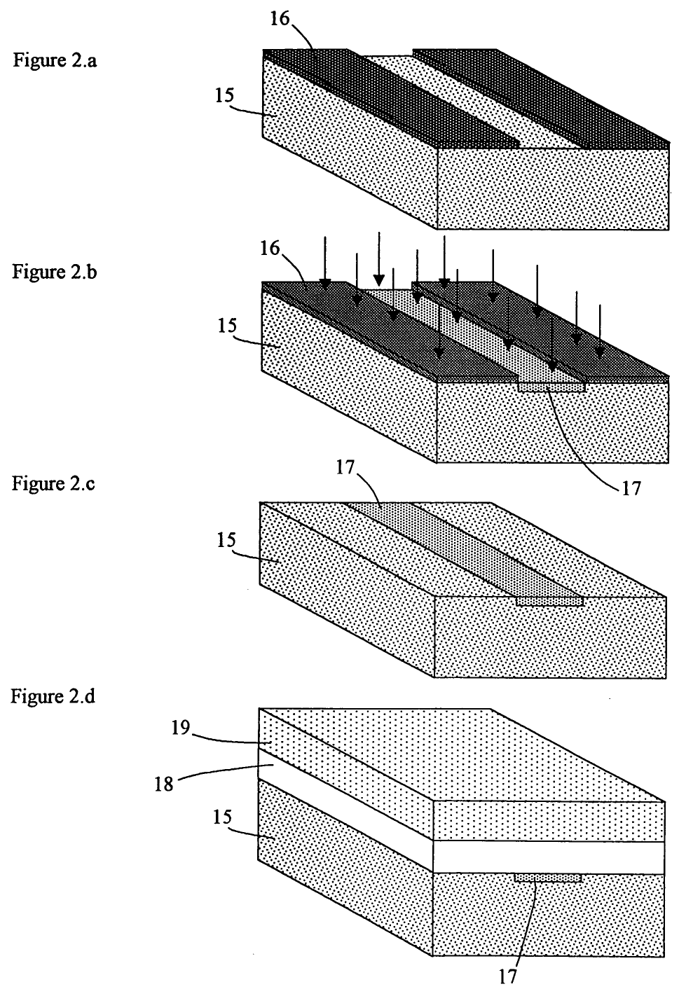

FIG. 2 shows a first method of making the core;

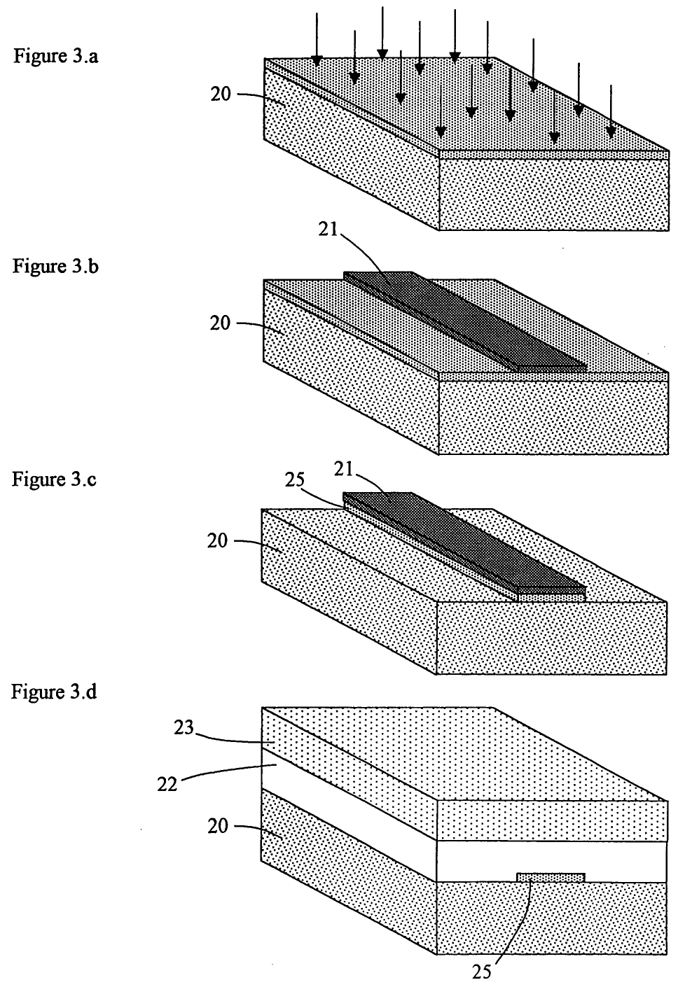

FIG. 3 shows a second method of making the core; and

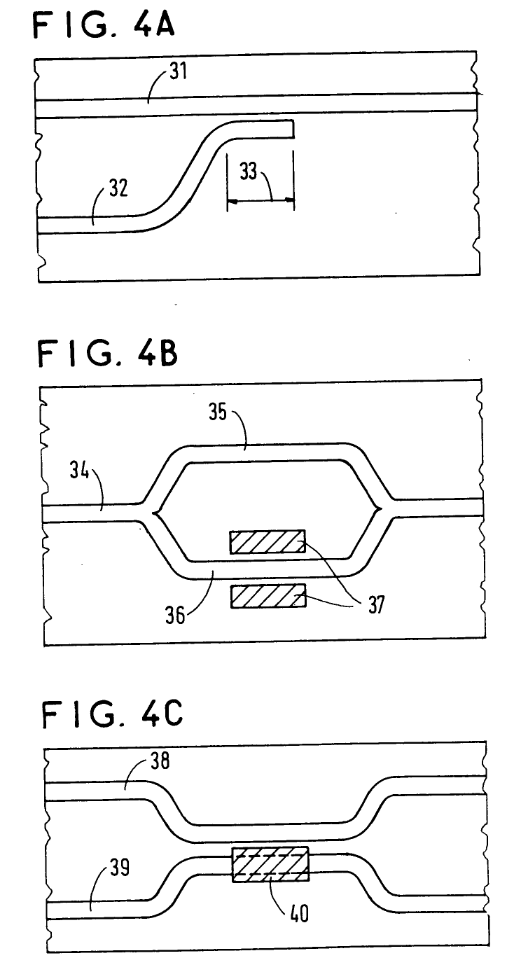

FIG. 4 shows a set of active devices seen from above.

In order to simplify describing the invention, only the making of the core of the active waveguide is described initially.

With reference to FIG. 1a, in a first variant, the substrate is silicon having an insulating layer made thereon, either by growing a thermal oxide, or by depositing a layer of silicon dioxide SiO₂, or of some other material such as Si₃N₄, Al₂₃, or SiON. These are dielectric materials commonly used in electronics and in optics, unlike glasses containing mobile ions. Nevertheless, it is not possible to guarantee that these materials have zero concentration of mobile ions. It can only be stated that this concentration is very low, e.g. less than 0.01%.

The substrate thus presents a top face or optical substrate 11 commonly made of silicon dioxide, and having a thickness of 5 μm to 20 μm, for example. In this case, the channel 12 made by implanting ions is integrated in the optical substrate, which is itself covered in an active layer 13. The refractive index of the channel is naturally-higher than that of silicon dioxide. The active layer is 5 μm thick, for example, is made of erbium-doped silicon dioxide, and presents a refractive index that is greater than that of the optical substrate, e.g. by 0.3%. It may optionally be a stack of thin layers. A covering layer 14, which can likewise be constituted by a stack of thin layers, is preferably provided on the active layer 13. This covering layer, which is likewise 5 μm thick, has a refractive index lower than that of the active layer and lower than that of the channel; in the present example it is constituted by non-doped silicon dioxide.

In a second variant, the substrate does not present an insulating layer, so it is the same as the optical substrate. It is constituted, for example, by a III-V type semiconductor compound, e.g. InP, GaAs, AlGaAs, or InGaAsP. Prior to depositing the resulting active layer, the channel is implanted with a doped material similar to the material of the substrate. Naturally, the various materials commonly in use in optics such as silica or lithium niobate are suitable for use as the optical substrate.

Whatever the variant that is adopted, the core formed by associating the channel 12 and the active layer 13 can support one or more propagation modes whose properties are a function of the optical characteristics and geometrical characteristics that are adopted.

With reference to FIG. 1b, when the refractive index of the channel is relatively low, e.g. 1.56, the extended GM propagation mode extends to a considerable extent in the active layer 13. The width of the channel, e.g. 7.5 μm, and the thickness of the active layer are selected in such a manner that the GM propagation mode is as close as possible to the propagation mode in optical fibers. This makes it possible to obtain a coupling coefficient with fibers having a value of 90%. The effective refractive index of the guided mode is lower than the refractive index of the active layer and lower than that of the channel; it is higher than the refractive index of the top face 11 and higher than that of the covering layer 14.

With reference to FIG. 1c, it should be observed that the core may also support a reduced PM propagation mode which extends much less into the active layer 13. It is then appropriate for the refractive index of the channel to be relatively high, e.g. 1.90. The width of the channel may be significantly smaller. The effective index of the guided mode in this case is higher than that of the active layer and lower than that of the channel. The reduced PM mode is subjected to very significant lateral confinement.

The ion implantation technique is used since it makes it possible to define precisely a channel that is very thin, having thickness of a few hundreds of nanometers (nm).

Furthermore, this technique now benefits from very great precision concerning the doses of ions that are implanted, typically precision to within 1%. The optical substrate of silicon dioxide has a refractive index which varies little or not at all, so it is possible to obtain very great precision concerning the index of the channel. By way of example, for titanium implanted at a concentration of 10¹⁶ ions per square centimeter (cm²) the precision concerning refractive index is to within 10⁻⁴, and for a concentration of 10¹⁷/cm² the precision is to within 10⁻³. This precision is particularly great when seeking to use the extended GM propagation mode since the index of the channel is a parameter which has a very significant effect on coupling with optical fibers.

With reference to FIG. 2a, a first method of fabricating the core comprises a first step which consists in making a mask 16 on the optical substrate 15 using a conventional photolithographic method. The mask 16 can be made of resin, metal, or any other material capable of constituting a barrier that ions cannot cross during implantation. The mask may optionally be obtained by a direct writing method.

With reference to FIG. 2b, the channel 17 is produced by implanting ions into the masked substrate. By way of example, when implanting titanium ions, the implanted concentration lies in the range 10¹⁶/cm² to 10¹⁸/cm² and the implanting energy lies in the range a few tens of kiloelectron-volts (keV) to a few hundreds of keV.

With reference to FIG. 2c, the mask has been removed, e.g. using a chemical etching method. The substrate is then subjected to annealing to reduce propagation losses within the core. Annealing serves in particular to eliminate defects in the crystal structure and to eliminate colored light-absorbing centers, and it also serves to stabilize the new chemical compounds and to bring the channel into stoichiometric equilibrium. By way of example, the annealing temperature lies in the range 400° C. to 500° C., and the annealing atmosphere is controlled or constituted by ambient air, while the duration of annealing is of the order of a few tens of hours.

With reference to FIG. 2d, the active layer 18 is then deposited on the substrate 5 by using any of the known techniques, providing they give rise to a material having low losses and a refractive index that is easily controlled. Finally, the covering layer 19 is optionally deposited on the active layer 18.

It should be observed that this first method presents the advantage of defining an active waveguide of structure that is perfectly plane since there is no etching step.

With reference to FIG. 3a, a second method of fabricating the core of the waveguide comprises a first step which consists in implanting the entire optical substrate 20. The concentration and the energy of implantation may be identical to the values mentioned above with reference to the first method.

With reference to FIG. 3b, the following step consists in making a mask 21 on the substrate 20. This mask has the same pattern as that used during the first method, but it is not subjected to the implantation step.

With reference to FIG. 3c, the channel 25 is etching the optical substrate to a depth that is not less than the implantation depth. Any known etching technique is suitable, providing it leads to acceptable geometrical characteristics for the channel, in particular concerning its profile and the surface state of its flanks.

With reference to FIG. 3d, the mask is removed and then the substrate is likewise subjected to annealing. The active layer 22 and possibly also the covering layer 23 are then deposited as in the first method.

In this second method, the drawbacks associated with etching are limited to a considerable extent since the channel is of small thickness.

There follows a description of how the invention makes it possible to make optically-active devices.

With reference to FIG. 4A, an amplifier comprises a first channel 31 that is rectilinear and that in association with the active layer constitutes the core of the active waveguide. In this case the control element is in the form of a second channel 32 that is curved, presenting a rectilinear coupling section 33 placed in the immediate vicinity of the first channel 31 and parallel thereto. The second channel 32 is provided to convey an optical pumping signal. It is made at the same time as the first channel by means of a mask which defines both channels.

FIG. 4B shows a modulator which consists in a so-called “Mach Zehnder” interferometer. In this case, the mask defines a waveguide 34 which splits into first and second channels 35 and 36, these two channels reuniting to form-a single waveguide. A section of the second channel 36 is surrounded by a pair of elongate electrodes 37 whose connections are not shown in the figure. These electrodes are deposited, for example, by using a thin layer technology on the active layer. In this case this layer is made of a material that has electro-optical properties, i.e. a material whose refractive index is a function of the electric field which is applied thereto. The control element consists in the combination of the second channel 36 and the pair of electrodes 37.

With reference to FIG. 4C, a switch consists in a coupler having first and second parallel channels 38 and 39 which come close together in a coupling section and then move apart again. These two channels are made using the same mask and they are covered in the active layer. By way of example, this layer is made of a material having thermo-optical properties, i.e. a material whose refractive index is a function of temperature. In the coupling section, above the second channel 39, an electrode 40 is deposited on the active layer, which electrode serves to heat said layer locally. The electrode 40 constitutes the control element.

The embodiments of the invention described above have been selected because of their concrete nature. Nevertheless, it is not possible to list exhaustively all of the embodiments covered by the invention. In particular, any step or any means described may be replaced by an equivalent step or means without going beyond the ambit of the present invention.

1/ An optically-active device comprising a control element (32-33, 37, 40) and a core on an optical substrate (11, 15, 20), said core having a channel (12, 17, 25, 31, 35-36, 38-39) and at least one active layer (13, 18, 22) arranged on said channel, the refractive index of the channel and that of the active layer being higher than that of the substrate,
the device being characterized in that said optical substrate (11, 15, 20) presents mobile ions at a concentration of less than 0.01%.

2/ A device according to claim 1, characterized in that it includes at least one covering layer (14, 19, 23) deposited on said active layer (13, 18, 22), the refractive index of said covering layer being lower than that of the active layer and lower than that of the channel (12, 17, 25, 31, 35-36, 38-39).

3/ A device according to claim 1 or claim 2, characterized in that said channel (12, 17) is integrated in said substrate (11, 15).

4/ A device according to claim 1 or claim 2, characterized in that said channel (25) projects from said substrate (20).

5/ A device according to any preceding claim, characterized in that the refractive index of said active layer (13, 18, 22) is equal to that of the substrate (11, 15, 20) multiplied by a factor greater than 1.001.

6/ A device according to any preceding claim, characterized in that the thickness of the set of active layers (13, 18, 22) lies in the range 1 μm to 20 μm.

7/ A device according to any preceding claim, characterized in that said channel (12, 17, 25, 31, 35-36, 38-39) is the result of implanting ions in said substrate (11, 15, 20).

8/ A device according to any preceding claim, characterized in that the face of the substrate (11, 15, 20) on which ion implantation is performed is made of silicon dioxide.

9/ A device according to any preceding claim, characterized in that said active layer (13, 18, 22) is made of silicon dioxide doped with a rare earth.

10/ A device according to any preceding claim, characterized in that said active layer (13, 18, 22) presents electro-optical properties.

11/ A device according to any preceding claim, characterized in that said active layer (13, 18, 22) presents thermo-optical properties.

12/ A method of fabricating an active device on an optical substrate, the method including a step of making at least one control element (32-33, 37, 40), and being characterized in that it comprises the following steps:
making a mask (16) on said substrate (15) to define the pattern of a channel (17);
implanting ions into the masked substrate;
removing said mask; and
depositing at least one active layer (18) on the substrate, the refractive index of said active layer being higher than that of the substrate.

13/ A method of fabricating an active device on an optical substrate, the method including a step of making at least one control element (32-33, 37, 40), and being characterized in that it further comprises the following steps:
implanting ions into the substrate (20);
making a mask (21) on said substrate to define the pattern of a channel (25);
etching the substrate to a depth that is not less than the implantation step;
removing said mask; and
depositing at least one active layer (22) on the substrate, the refractive index of said active layer being greater than that of the substrate.

14/ A method according to claim 12 or claim 13, characterized in that it includes a step of annealing the substrate (15, 20) following the step of ion implantation step.

15/ A method according to claim 12 or claim 13, characterized in that it includes a step of depositing a covering layer (19, 23) on said active layer (18, 22), the refractive index of said covering layer being lower than that of the active layer and lower than that of the channel (17, 25).

16/ A method according to claim 12 or claim 13, characterized in that the refractive index of said active layer (18, 22) is equal to that of the substrate (15, 20) multiplied by a factor greater than 1.001.

17/ A method according to claim 12 or claim 13, characterized in that the thickness of the set of active layers (18, 22) lies in the range 1 μm to 20 μm.

18/ A method according to claim 12 or claim 13, characterized in that the face (15, 20) of the substrate on which ion implantation is performed is made of silicon dioxide.

19/ A method according to claim 12 or claim 13, characterized in that the material of said active layer (18, 22) is silicon dioxide doped with a rare earth.

20/ A method according to claim 12 or claim 13, characterized in that the material of said active layer (18, 22) presents electro-optical properties.

21/ A method according to claim 12 or claim 13, characterized in that the material of said active layer (18, 22) presents thermo-optical properties.
